(19) United States
(12) Patent Application Publication
(10) Pub. No.: US 2015/0018460 A1
(43) Pub. Date: Jan. 15, 2015

(54) SYSTEMS AND METHODS FOR PROVIDING A THERMOPLASTIC PRODUCT COMPRISING A RECYCLED MATERIAL

(71) Applicant: Maxwell Products, Inc., Salt Lake City, UT (US)

(72) Inventors: Michael P. Guymon, Ogden, UT (US); Trent N. Baker, Grantsville, UT (US)

(21) Appl. No.: 14/214,184

(22) Filed: Mar. 14, 2014

Related U.S. Application Data
(60) Provisional application No. 61/800,531, filed on Mar. 15, 2013.

(51) Int. Cl. C08K 11/00; C08L 55/02; C08L 23/14

(52) U.S. Cl. CPC C08K 11/005; C08L 23/14; C08L 55/02; C08L 2207/20
USPC 524/21; 524/59; 524/66; 524/1; 525/55; 524/443

(57) ABSTRACT

The present invention relates to thermoplastic products. In particular, the present invention relates to systems and methods for providing a thermoplastic product that includes one or more recycled materials. In some non-limiting implementations, the recycled materials are selected from eggshells, slag, solid output from an incinerator, and/or asphalt shingles. In some cases, the recycled materials comprise between about 0.1% and about 95%, by weight, of the thermoplastic product. In some cases, the recycled materials have a particle size between about one inch and about 300 mesh. Other implementations are also described.

### CROSS-REFERENCE TO RELATED APPLICATION

This application claims priority to U.S. Provisional Patent Application Ser. No. 61/800,531, filed Mar. 15, 2013, and entitled “SYSTEMS AND METHODS FOR PROVIDING A THERMOPLASTIC PRODUCT COMPRISING A RECYCLED MATERIAL;” the entire disclosure of which is hereby incorporated by reference.

### BACKGROUND OF THE INVENTION

1. Field of the Invention

The present invention relates to thermoplastic products. In particular, the present invention relates to systems and methods for providing a thermoplastic product that includes one or more recycled materials. In some non-limiting implementations, the recycled materials include eggshells, asphalt shingles, tar paper, slag, and/or incinerator solid output.

2. Background and Related Art

Thermoplastics typically include one or more polymers that change to a liquid or semi-liquid state when the polymers are heated sufficiently, and that freeze or solidify to a rigid or semi-rigid state when the polymers are cooled sufficiently. While thermoplastics have a wide variety of uses, in some cases, such materials are used as pavement joint sealants, pavement crack sealants, waterproofing membranes, hot melt adhesives, roofing asphalt, paving grade asphalt cement, and a variety of other products. In many such cases, thermoplastics (e.g., thermoplastic sealants, waterproofing membranes, hot melt adhesives, etc.) are heated, mixed, and then applied to a surface (e.g., pavement, a roof, etc.), where they are allowed to cool and harden.

When thermoplastics are used as sealants, membranes, adhesives, and/or in a similar manner, they are often used to minimize water infiltration, prevent the accumulation of debris, prolong the life of, and otherwise protect the material or structure to which they are applied. In this regard, some examples of materials that can be protected by thermoplastics (such as thermoplastic sealants) include, but are not limited to, asphalt pavement and Portland cement pavement. Moreover, some non-limiting examples of structures that can be protected by thermoplastics include roads, roofs, bridge decks, retention ponds, sidewalks, parking lots, tarmacs, and a wide variety of other structures.

Although thermoplastics have been found to be useful in many applications, some thermoplastics are not without their shortcomings. Indeed, as some thermoplastics (i.e., some thermoplastic sealants) include a one or more non-renewable natural resources, some such thermoplastics can be relatively expensive to produce and be relatively detrimental to the environment. Moreover, as some thermoplastics can be relatively abrasive when they are melted, they may shorten the usable life of pumps and other instruments that are used to melt, move, handle, and/or apply the thermoplastics to a surface.

Thus, while techniques currently exist that are used to produce thermoplastics, challenges still exist, including those discussed above. Accordingly, it would be an improvement in the art to augment or even replace current techniques with other techniques.

### SUMMARY OF THE INVENTION

The present invention relates to thermoplastic products. In particular, the present invention relates to systems and methods for providing a thermoplastic product that includes one or more recycled materials.

In some non-limiting implementations, the present invention takes place in association with a thermoplastic product containing a thermoplastic material and a recycled material. In this regard, thermoplastic material can include any suitable type and grade of polymer-containing materials that change to a liquid or semi-liquid state when heated sufficiently, and that freeze or solidify to a rigid or semi-rigid state when cooled sufficiently. In this regard, some examples of such polymer-containing materials include, but are not limited to, one or more of the following: asphalts, asphalt cements, roofing asphalts, rubbers, thermoplastic elastomers, polybutadienes, styrene butadiene styrene block copolymers, styrene isobutyl butadiene copolymers, styrene ethylene butadiene styrene, polybenzimidazole, hydrogenated styrene butadiene styrene, styrene butadiene rubber, nitrile rubber, ethylene butadiene styrene, ethylene vinyl acetate, synthetic latex, latex, natural rubber, olefins, polyolefins, polyethylene, high density polyethylene, low density polyethylene, linear low density polyethylene, polypropylene, high density polypropylene, low density polypropylene, ethylene propylene copolymers, polystyrene, high density polystyrene, low density polystyrene, high impact polystyrene, polybutylene, polyisobutylene, polyvinyl chloride, polyurethane, polytetrafluoroethylene, light oils, vacuum gas oils, ground tire rubber, one or more oils, polymers, silicon, tar, and/or any other suitable materials exhibiting thermoplastic characteristics.

The recycled material can comprise virtually any used, reused, discarded, low-cost, and/or recycled material that is suitable for use in a thermoplastic product. Some examples of suitable recycled materials include, but are not limited to, incinerator solid output, eggshell, and one or more: metalcines polymer materials (e.g., tire rubber, linear low-density polyethylene, ethylene-propylene copolymers, syndiotactic polystyrene (“SDS”) materials, SPR materials, wax products (e.g., paraffin, microcrystalline waxes, fatty amide waxes, oxidized Fischer-Tropsch waxes, etc.), slag (e.g., slag from mineral refining, slag from iron and steel manufacturing, slag from iron and steel recycling, and/or slag from any other suitable source), and materials that have already been used for an intended purpose (e.g., recycled asphalt shingles, recycled tar paper, recycled asphalt pavement, packaging materials, etc.).

In some non-limiting implementations, the present invention relates to a thermoplastic product (e.g., a sealant composition) that includes a thermoplastic mixture containing a thermoplastic material and a recycled material (e.g., eggshell, asphalt shingles, slag, etc.), wherein the recycled material accounts for between about 0.1% and about 95%, by weight, of the thermoplastic product, and wherein the recycled material (e.g., eggshell) has a particle size between about 1 inch in diameter and about 300 mesh.

In other non-limiting implementations, the present invention relates to an asphalt product containing a thermoplastic mixture that includes asphalt, wherein the asphalt accounts for between about 0% and about 30% of the asphalt product, by weight. Additionally, in some implementations, the asphalt product contains a recycled material (e.g., incinerator solid output, eggshell, recycled asphalt shingles, recycled asphalt pavement, slag, etc.).

While the described methods and processes invention may be particularly useful in the areas of sealants (e.g., pavement crack sealants, joint sealants, and other sealants), waterproofing membranes, roofing asphalt, paving grade asphalt cement, and hot melt adhesives, those skilled in the art will appreciate that the described methods, processes, and materials can be used in a variety of different applications and in a variety of different areas of manufacture to yield a thermoplastic product for use or application to a surface, wherein the thermoplastic product includes a recycled material. Some non-limiting examples of such uses and applications include the use of the described thermoplastic products in pavement maintenance (e.g., as asphalt crack sealants, concrete joint sealants, bridge deck membranes, bridge expansion joint sealants, wide crack sealants, pothole patching products, concrete spall repair products, concrete patching products, paving joint adhesives, traffic loop detector sealants, pavement marker adhesives, colored sealants and products, hot applied rubberized chip seal binders, chip seal binder additives, hot applied seal coats, etc.), roofing (e.g., as shingle tab adhesives, shingle lamination adhesives, waterproofing membranes, polymer roofing asphalt, polymer modified bitumen, blown roofing asphalt, planter box membranes, rolled roofing seam adhesives, ice and snow shields, vertical surface adhesives, vertical surface repair, perforation repair, white hot applied waterproofing membranes and top coatings, silver hot applied waterproofing membranes and top coatings, tar paper, gray hot applied waterproofing membranes and top coatings, etc.), paving (e.g., as paving grade asphalt cements, polymer modified paving asphalt cements, paving additives and modifiers, etc.), adhesives (e.g., as thermoplastic adhesive for crafts, packaging, construction materials, and/or any other suitable application), gaskets, thermoplastic paints, paints, thermoplastic sealants, silicon sealants, asphalt, sealants, caulking, hot melt or hot glue adhesives, extruded rubber products, pre-weighed polymers, and any other suitable process that allows for the use of a thermoplastic material comprising one or more recycled materials, such as eggshells, slag, recycled shingles, incinerator solid output, etc.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWING

In order that the manner in which the above recited and other features and advantages of the present invention are obtained, a more particular description of the invention will be rendered by reference to specific embodiments thereof, at least one of which is illustrated in the appended drawing. Understanding that the drawing depicts only typical embodiments of the present invention and is not, therefore, to be considered as limiting the scope of the invention, the present invention will be described and explained with additional specificity and detail through the use of the accompanying drawing in which:

FIG. 1 illustrates a representative embodiment of a method for producing a thermoplastic product comprising one or more recycled materials.

### DETAILED DESCRIPTION OF THE INVENTION

The present invention relates to thermoplastic products. In particular, the present invention relates to systems and methods for providing a thermoplastic product that includes one or more recycled materials.

The described thermoplastic products can comprise any suitable thermoplastic product that can include one or more recycled materials. Some non-limiting examples of such products include sealants (e.g., pavement crack sealants, joint sealants, wide crack sealants, pavement joint sealants, asphalt sealants, concrete sealants, bridge expansion joint sealants, colored sealants, and other sealants), waterproofing membranes, paving grade asphalt cement, hot melt adhesives, pavement maintenance materials (e.g., bridge deck membranes, pothole patching products, concrete spall repair products, concrete patching products, paving joint adhesives, pavement marker adhesives, colored products, hot applied rubberized chip seal binders, chip seal binder additives, hot applied seal coats, etc.), roofing (e.g., roofing asphalts, shingle tab adhesives, shingle lamination adhesives, waterproofing membranes, polymer roofing asphalts, polymer modified bitumens, blown roofing asphalts, rolled roofing seam adhesives, ice and snow shields, vertical surface adhesives, vertical surface repairs, perforation repairs, white hot applied waterproofing membranes and top coatings, sliver hot applied waterproofing membranes and top coatings, gray hot applied waterproofing membranes and top coatings, etc.), paving materials (e.g., paving grade asphalt cements, polymer modified paving asphalt cements, paving additives and modifiers, etc.), adhesives (e.g., thermoplastic adhesives for crafts, packaging, construction, and/or any other suitable application), planter box membranes, gaskets, thermoplastic paints, paints, asphalt sealants, cement sealants, caulking, extruded rubber products, pre-weighed polymers, and virtually any other suitable product containing a thermoplastic material and one or more recycled materials (e.g., eggshell, recycled asphalt shingles, recycled asphalt pavement, slag, incinerator solid output, and/or one or more other recycled materials). In some embodiments, however, the thermoplastic product comprises a sealant.

With respect to the thermoplastic material in the thermoplastic product, the thermoplastic material can comprise virtually any suitable thermoplastic (or combination of thermoplastics) that is capable of being mixed with a recycled material to form a thermoplastic product. In this regard, some non-limiting examples of suitable thermoplastic materials include any suitable type and grade of one or more: asphalts, asphalt cements, roofing asphalts, rubbers, thermoplastic elastomers, polybutadienes, styrene butadiene styrene block copolymers, styrene isobutyl butadiene copolymers, styrene ethylene butadiene styrene, polybenzimidazole, hydrogenated styrene butadiene styrene, styrene butadiene rubber, nitrile rubber, ethylene butadiene styrene, ethylene vinyl acetate, synthetic latex, latex, natural rubber, olefins, polyolefins, polyethylene, high density polyethylene, low density polyethylene, linear low density polyethylene, polypropylene, high density polypropylene, low density polypropylene, ethylene propylene copolymer, polystyrene, high density polystyrene, low density polystyrene, high impact polystyrene, polybutylene, polyisobutylene, polyvinyl chloride, polyurethane, polytetrafluoroethylene, light oils, vacuum gas oils, ground tire rubber, one or more oils, polymers, silicon, tar, Trinidad lake asphalt, Great Salt Lake oil, polymer materials, and/or any other material or materials exhibiting thermoplastic characteristics (either alone or when mixed with other materials). In some embodiments, however, the thermoplastic material comprises a known or novel asphalt.

With respect to the recycled material, the thermoplastic product can comprise any suitable recycled, reused, discarded, disposable, and/or low-cost material or materials that allow the thermoplastic product to function as a thermoplastic. Indeed, in some embodiments, the recycled material is selected from any suitable incinerator solid output, eggshell, ground tire material, linear low density polyethylene, ethylene polypropylene copolymer, SPS material, SPR material, wax product (e.g., paraffin, microcrystalline waxes, fatty amide waxes, oxidized Fischer-Tropsch waxes, etc.), metalcine, plastic (e.g., polycarbonate, acrylonitrile butadiene styrene (“ABS”), etc.), recycled asphalt shingles, recycled tar paper, recycled asphalt pavement, recycled cement (e.g., Portland cement), slag (e.g., slag from mineral refining, slag from iron and steel manufacturing, slag from iron and steel recycling, and/or slag from any other suitable source), recycled packaging materials (e.g., polystyrene foam, etc.), and/or any other suitable recycled or reused material or any suitable combination of the foregoing. In some embodiments, however, the recycled material is selected from incinerator solid output, eggshell, recycled asphalt shingles, recycled asphalt pavement, and/or slag.

Where the recycled material comprises incinerator solid output, the recycled material can comprise any suitable solid output produced by an incinerator, including, without limitation, fly ash and/or bottom ash. Moreover, the solid output can be obtained from the incineration of any suitable material, including, but not limited to paint (i.e., automotive paint, etc.) and/or another material. While the solid output can comprise any suitable chemicals, in some embodiments, the output comprises calcium oxide, iron oxide, iron sulfide, iron carbonate, titanium oxide, hematite pigment, and/or iron oxide.

Where the recycled material comprises eggshell, the eggshell can comprise any suitable type of eggshell including, without limitation, eggshells from chickens, ducks, geese, quail, ostriches, emus, and/or any other suitable bird or animal. In some embodiments, however, the eggshell comprises chicken eggshells.

In some embodiments in which the recycled materials comprise eggshell, a portion (if not all of) certain proteinaceous materials (e.g., the yolk, membranes, albumen, chalazae, etc.) is optionally separated from the eggshell before the eggshell is added to the other ingredients of the thermoplastic product. In this regard, the proteinaceous material can be removed from the eggshells in any suitable manner, including, without limitation, through cracking and draining the eggshell in combination with any known or later-developed: non-chemical separation method (e.g., a method that uses a knife or other object to scrape membrane from shell fragments; a method using steam heat, mechanical abrasion (e.g., via a heated auger), a light vacuum, and/or a cyclonic device to separate the eggshell from the membrane; a method that includes blending eggshells in water and then removing the supernatant; etc.), an air floatation separation method (e.g., a method that includes placing eggshells in water, grinding the shells, and then injecting air into the water to cause the relatively light protein to float while allowing the relatively heavy shell to drop); a fluid tank method (e.g., a method that involves placing eggshells in a fluid tank comprising water and acetic acid, and applying cavitation to separate the membrane from the eggshell); and/or any other suitable method for separating an eggshell from undesired proteinaceous materials.

The recycled material can have any suitable particle size that allows the thermoplastic product to function as intended. In some embodiments, the recycled material (e.g., one or more of the following: eggshells, recycled asphalt shingles, recycled asphalt pavement, incinerator solid output, slag, etc.) has an average particle size having a length and a width (or an average diameter) that are each less than about 1 inch. In other embodiments, the recycled material has an average particle size less than about 1 mm. In still other embodiments, the recycled material has a particle size between about 50 mesh and about 300 mesh. In yet other embodiments, the recycled material has a particle size between about 200 and about 300 mesh. In still other embodiments, the recycled material has a particle size between about 200 mesh and about 250 mesh. As the particle size of the recycled material can vary for use in different applications and in different thermoplastic products, in some embodiments, the recycled materials have a particle size that falls in any suitable sub-range or combination of the preceding ranges. For instance, in some embodiments in which recycled materials with a larger particle size are desirable (e.g., in a wide crack sealant), the recycled material has a particle size between about 50 mesh and about 100 mesh.

The particle size of the recycled materials can be reduced to a desired size in any suitable manner, including, without limitation, through the use of a blender, a grinder, a mill, a mortar and pestle, a crushing device, a press, and/or any other suitable method, system, and/or apparatus. Indeed, in some embodiments, the recycled materials are ground through the use of a blender.

In addition to including one or more thermoplastic materials and one or more recycled materials (e.g., eggshells, incinerator solid output, slag, recycled shingles, etc.), the described thermoplastic products can comprise any other suitable ingredient or ingredients that allow the thermoplastic products to be used for one of the aforementioned applications. In this regard, some non-limiting examples of other suitable ingredients that can be included in the thermoplastic product include perlite microspheres, ceramic microspheres, talc, glass, cement, kaolin, limestone, sodium bentonite, sulfur, mineral fillers, aggregates, fibers, tar sands, plasticizers, anti-strip agents, polyester fibers, light weight aggregates, calcium oxide, magnesium oxide, titanium dioxide, aluminum (e.g., aluminum metal flake), graphite, carbon, iron oxide, iron sulfide, iron carbonate, recycled Portland cement, zeolite, diatomite, sepiolite, calcium bentonite, quartz, diatomaceous earth, any other suitable materials, and/or any suitable combination thereof. In some non-limiting embodiments, the recycled materials are used in place of a portion (if not all) of the limestone or other filler that is used in a conventional or novel thermoplastic product.

The various ingredients of the described thermoplastic product can be present in the product at any suitable concentration. With reference to the recycled material (e.g., eggshells, incinerator solid output, recycled shingles, etc.), in some embodiments, the recycled material comprise between about 0.01% and about 95%, by weight, of the described thermoplastic product. In other embodiments, the recycled material comprises between about 1% and about 70%, by weight, of the thermoplastic product. In still other embodiments, the recycled material comprises between about 5% and about 50%, by weight, of the thermoplastic product. In still other embodiments, the recycled material comprises between about 10% and about 35%, by weight, of the thermoplastic product. In yet other embodiments, the recycled material comprises any suitable sub-range of any of the aforementioned ranges. Indeed, in some embodiments, the recycled material comprises between about 8% and about 30%, by weight, of the thermoplastic product.

The ingredients of the thermoplastic material can also be present in any suitable concentration. In one non-limiting example, Table 1 shows some representative weight percentage ranges of some ingredients for inclusion into various thermoplastic products of the present invention. As used in this example and throughout this specification, the term raw material, and variations thereof, may refer to various ingredients of a thermoplastic product before such ingredients are heated with other ingredients to form a liquid or semi-liquid phase of the thermoplastic product.

TABLE 1

| | Weight % |
|---|---|
| Raw Material | Range |
| Asphalt Cement | 0-99.9% |
| Light Oils | 0-95% |
| Styrene Butadiene Styrene Block Copolymers | 0-20% |
| Styrene Butadiene Rubber | 0-20% |
| Polyolefins | 0-99.9% |
| Ground Tire Rubber | 0-50% |
| Ground Limestone | 0-70% |
| Ground Talc | 0-70% |
| Ground Sodium Bentonite | 0-15% |
| Anti Strip Agents | 0-2% |
| Plasticizers | 0-5% |
| Roofing Asphalt | 0-99.9% |
| Tar Sands | 0-99.9% |
| Trinidad Lake Asphalt | 0-99.9% |
| Great Salt Lake Oil | 0-70% |
| Polyester Fiber | 0-30% |
| Light Weight Aggregates (specific gravity 1.0 to 2.0 g/ml) | 0-80% |
| Medium Light Weight Aggregates (specific gravity 2.0 to | 0-80% |
| 3.0 g/ml) | |
| Perlite microspheres | 0-80% |
| Calcium Oxide | 0-70% |
| Magnesium Oxide | 0-70% |
| Titanium dioxide | 0-80% |
| Aluminum Metal Flake | 0-90% |
| Carbon black | 0-50% |
| Polystyrene | 0-20% |
| Iron Oxide | 0-95% |
| Iron Carbonate | 0-95% |
| Iron Sulfide | 0-95% |
| Asphalt Shingles | 0-70% |
| Eggshells | 0-70% |
| Iron | 0-70% |
| Steel | 0-70% |
| Slag from Mineral Refining | 0-95% |
| Slag from Iron and Steel Manufacturing | 0-95% |
| Slag from Iron and Steel Recycling | 0-95% |
| Recycled Portland Cement | 0-95% |

Those skilled in the art will appreciate that the raw materials and corresponding formula percentage ranges are representative only. Accordingly, some embodiments of the present invention embrace the addition of other raw materials and/or other percentage ranges (including, without limitation, sub-ranges of the ranges in Table 1), particularly for roofing asphalt, asphalt cement, waterproofing membranes, and hot melt adhesives, as well as sealants which contain fiber and aggregate or no asphalt at all.

In another non-limiting example, Table 2 provides representative weight percentage ranges of ingredients for inclusion into some embodiments of the described thermoplastic products:

TABLE 2

| | Weight % |
|---|---|
| Raw Material | Range |
| Asphalt Cement | 49%-77% |
| Light Oils | 0%-23% |
| Styrene butadiene Styrene block copolymers | 0%-6% |
| Styrene butadiene Rubber | 0%-4% |
| Polyolefins | 0%-3% |
| Ground Tire Rubber | 0%-22% |
| Ground Limestone | 0%-34% |
| Recycled Material (e.g., eggshell, asphalt shingles, slag, tar | 0%-51% |
| paper, asphalt pavement, ethylene polypropylene copolymer, | |
| etc.) | |
| Ground Talc | 0%-8% |
| Ground Sodium Bentonite | 0%-9% |
| Anti Strip Agents | 0%-1% |
| Plasticizers | 0%-1% |

Those skilled in the art will appreciate that the raw materials and corresponding formula percentage ranges are representative only. Accordingly, embodiments of the present invention embrace the addition of other raw materials and/or other percentage ranges (including sub-ranges of the ranges in Table 2).

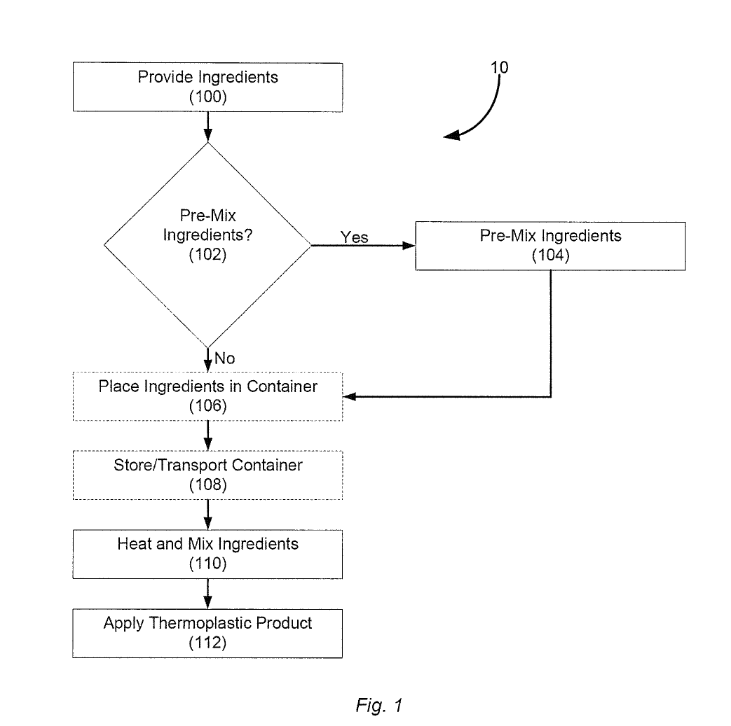

The described thermoplastic products can be made in any suitable manner. By way of non-limiting illustration, FIG. 1 shows a representative method 10 for obtaining a thermoplastic product. While the method of FIG. 1 can be rearranged, shortened, added to, and otherwise modified in any suitable manner, that figure shows that, in at least some embodiments, execution begins at step 100, wherein raw ingredients of the thermoplastic product are provided. By way of non-limiting example, the raw materials are weighed and then the raw ingredients (or a portion thereof) are transferred into a vessel (or other location).

At decision block 102, a determination is made as to whether or not some or all of the ingredients are to be pre-mixed. In one embodiment, the pre-mixing process includes heating (e.g., to between about 300° F. and about 430° F. or another suitable temperature) and mixing various ingredients that are present in the vessel.

If it is determined at decision block 102 that some or all of the ingredients are to be pre-mixed, execution proceeds to step 104, where the pre-mixing takes place. The pre-mixed ingredients are then optionally cooled to a packaging temperature (e.g., between about 200° and about 215° F. or another suitable temperature) and placed into a container at step 106. In some such embodiments, additional materials may also be added to the container. While this process of placing the pre-mixed ingredients in a container can be accomplished in any suitable manner, in one non-limiting example, the process of transferring includes: (i) pumping the ingredient mixture through a colloid mill to a mix tank and/or packaging tank; (ii) adding measured amounts of ground talc, ground tire rubber, ground sodium bentonite, and/or other ingredients to the mixture coming from the vessel; (iii) allowing the packaging tank to agitate; (iv) adding a measured amount of ground recycled materials (e.g., eggshell, incinerator output, recycled shingles, and/or any other suitable recycled material) and/or other fillers while agitating; and (v) packaging the resulting mixture. The packaged mixture may be cooled to a packaging temperature (e.g., 180° F.-250° F. or another suitable temperature) or an ambient temperature.

Alternatively, if it is determined at decision block 102 that the ingredients are not to be pre-mixed, execution optionally proceeds directly to step 106 (or a following step (e.g., 108, 110, and 112)).

At step 106, one or more ingredients for a thermoplastic product are placed into a container (e.g., a box, a carton, a bag, a crate, a tube, box, etc.). Step 108 shows that the ingredients are then optionally stored and/or transported. At a mixing site, such as at a job or other site, the ingredients of one or more containers (and any additional ingredients) are mixed together at step 110 to obtain a thermoplastic product. In at least some embodiments, the process for mixing includes providing heat to mix the ingredients. At step 112, the thermoplastic product is then applied for use.

In the method 10 shown in FIG. 1, the recycled materials (e.g., eggshells, slag, incinerator solid output, etc.) can be added to the other ingredients of the thermoplastic material at any suitable time, including, without limitation, at step 100, step 102, step 104, step 106, step 110, and/or step 112. Indeed, in some embodiments, the recycled materials are added at step 100.

The described systems, methods, and products can be varied in any suitable manner that allows for the production of a thermoplastic product comprising one or more recycled materials. Indeed, in some non-limiting embodiments, the various ingredients of the described thermoplastic product are optionally stored and/or transported in a container that is capable of becoming part of the thermoplastic product. While the recycled material can be stored in any suitable location in such embodiments (e.g., along with thermoplastic materials in the packaging), in some embodiments, the recycled material is actually included as part of the packaging. In some such embodiments, the packaged ingredients and corresponding package can be heated and mixed together to form a thermoplastic product comprising a recycled material. For a more detailed description of the incorporation of packaging into a thermoplastic product, see U.S. Pat. No. 8,283,409, filed May 6, 2011, and entitled “Systems and Methods for Providing a Thermoplastic Product that Includes Packaging Therefor;” the entire disclosure of which is hereby incorporated by reference.

In addition to the aforementioned features, the described thermoplastic products may have one or more additional features. In one non-limiting example, because the described thermoplastic products comprise one or more recycled materials, the described products (or at least portions thereof) can comprise sustainable materials. Additionally, while in some cases eggshells, incinerator solid output, old asphalt shingles, slag, etc. may otherwise be discarded in landfills (which may be costly, attract vermin, cause pollution, and otherwise be undesirable), the described systems and methods may provide an environmentally-friendly, cost-effective, and clean way to dispose of such materials. In still another non-limiting example, because some recycled materials (e.g., eggshells) can be porous and comprise voids, the use of such materials allows some embodiments of the described thermoplastic product to be less dense than some competing thermoplastic products. In yet another example, the use of eggshells, incinerator solid output, slag, recycled shingles, and/or other recycled materials as filler in thermoplastic products may be less abrasive than some conventional fillers. Accordingly, the use of the described recycled materials can be less damaging to pumps (and other equipment for handling thermoplastic products) than some conventional fillers.

Thus, as discussed herein, the embodiments of the present invention embrace thermoplastic products. In particular, the present invention relates to systems and methods for providing a thermoplastic product that includes one or more recycled materials. The present invention may be embodied in other specific forms without departing from its spirit or essential characteristics. The described embodiments and examples are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A thermoplastic product containing:
a thermoplastic material; and
a recycled material selected from: (i) incinerator solid output, (ii) eggshell, (iii) recycled asphalt shingles, (iv) recycled asphalt pavement, (v) slag, (vi) an SPS material, (vii) an SPR material, (viii) a metalcine, (ix) an ethylene polypropylene copolymer, (x) ABS, (xi) recycled tar paper, and (xii) combinations thereof,
wherein the thermoplastic material and the recycled material are mixed together to form the thermoplastic product.

2. The product of claim 1, wherein the recycled material comprises the incinerator solid output.

3. The product of claim 1, wherein the recycled material comprises the eggshell.

4. The product of claim 1, wherein the recycled material comprises asphalt shingles.

5. The product of claim 1, wherein the recycled material comprises slag.

6. The product of claim 3, wherein the eggshell comprises particles having a size between about 200 mesh and about 300 mesh.

7. The product of claim 1, wherein the thermoplastic material comprises at least one of an asphalt material and an oil.

8. The product of claim 1, wherein the recycled material comprises between about 1% and about 70%, by weight, of the thermoplastic product.

9. The product of claim 1, wherein the thermoplastic product comprises a material selected from:
a. a sealant;
b. an asphalt;
c. a waterproofing material;
d. an asphalt cement;
e. a hot melt adhesive;
f. a pothole patching product;
g. a pavement marker adhesive;
h. a bridge deck membrane;
i. a hot applied rubberized chip seal binder;
j. a chip seal binder additive;
k. a blown roofing asphalt;
l. a planter box membrane;
m. a rolled roofing seam adhesive;
n. a gasket;
o. a thermoplastic paint;
p. an extruded rubber product;
q. a pre-weighed polymer; and
r. a vertical surface adhesive.

10. A sealant composition, comprising:
a thermoplastic material; and
eggshells, wherein the eggshells comprise between about 0.1% and about 95%, by weight, of the sealant composition.

11. The composition of claim 10, wherein the eggshells comprise a particle size between about one inch and about 300 mesh.

12. The composition of claim 10, wherein the eggshells comprise between about 5% and about 50% of the sealant composition, by weight.

13. The composition of claim 10, wherein the sealant composition is selected from:
a. a pavement joint sealant;
b. a pavement crack sealant;
c. an asphalt joint sealant;
d. a concrete joint sealant;
e. a bridge expansion joint sealant;
f. a wide crack sealant; and
g. a traffic loop detector sealant.

14. An asphalt product containing a thermoplastic mixture comprising:
asphalt, wherein the asphalt comprises between about 0% and about 30% of the asphalt product, by weight; and
a recycled material selected from: (i) incinerator solid output, (ii) eggshell, (iii) slag, (iv) recycled shingles, (v) ABS, (vi) an ethylene polypropylene copolymer, and (vii) combinations thereof.

15. The product of claim 14, wherein the recycled material comprises eggshell.

16. The product of claim 14, wherein the recycled material comprises slag.

17. The product of claim 14, wherein the recycled material comprises incinerator solid output.

18. The product of claim 17, wherein the incinerator solid output comprises solid output from incinerated paint.

19. The product of claim 14, wherein the recycled material comprises a particle size between about 200 and about 300 mesh.

20. The product of claim 14, wherein the recycled materials comprises between about 0.1% and about 35%, by weight, of the asphalt product.
